(19) United States
(12) Patent Application Publication
(10) Pub. No.: US 2022/0184430 A1
(43) Pub. Date: Jun. 16, 2022

(54) TRANSPARENT FACE MASKS AND RELATED METHODS

(71) Applicant: PuraVita, LLC, Reno, NV (US)

(72) Inventors: Paul Hickey, Reno, NV (US); Darin Long, Reno, NV (US); Jeff Nemelka, Reno, NV (US)

(21) Appl. No.: 17/247,537

(22) Filed: Dec. 15, 2020

(51) Int. Cl. A62B 18/02; A41D 13/11; A41D 31/10; A41D 31/30; D04H 1/56; A62B 18/08; A62B 23/02

(52) U.S. Cl. CPC A62B 18/025; A41D 13/1107; A41D 31/10; A41D 31/30; A62B 23/025; D04H 1/56; A62B 18/084; A62B 23/02; D10B 2501/042; A41D 13/1161

(57) ABSTRACT

A face mask is disclosed that comprises a body including a material exhibiting a refractive index between 1.2 and 1.7, at least one strap for securing the face mask to a head of a wearer, and an element located and configured to enable adjustment of a pressure between the face mask and a wearer's face. A method of producing a face mask is also disclosed, as is a face mask including a sealant disposed on an inner surface of the face mask. A face mask comprising a polymeric material is also disclosed.

### TECHNICAL FIELD

Embodiments of the disclosure relate generally to face masks. More particularly, this disclosure relates to transparent face masks that may be used as personal protective equipment and methods of manufacturing such masks.

### BACKGROUND

Face masks are often used as personal protective equipment in a variety of industries. For example, healthcare professionals use surgical face masks as protection against airborne pathogens, and construction workers use N95 masks as protection against harmful particulates. Face masks have become commonplace in society as protection against air pollution and pathogenic infection. Conventional face masks are produced in several varieties having differing protective capabilities. For example, surgical masks are designed to prevent infections in patients by trapping pathogens expelled in liquid droplets and aerosols from the wearer's mouth and nose. However, they do not form a tight seal around the wearer's face and are not designed to protect the wearer from inhaling airborne bacteria or viral particulates, making them less effective than N95 masks and other respirators. N95 masks, on the other hand, are designed to protect the wearer from inhaling hazardous particulates. However, N95 masks do not offer protection against harmful gases or vapors, and may be ineffective as protection against smaller pathogenic microorganisms.

Despite having differing protective capabilities, the design of face masks is generally similar. For example, most conventional face masks are designed to cover the mouths and noses of humans. Because materials used to produce face masks are not transparent, face masks are usually opaque and conceal the bottom half of the face from view. Since a considerable amount of human communication is non-verbal and a significant portion of that non-verbal communication depends on the ability to see a person's mouth, conventional masks have failed to meet the needs of the industry. This failure is of unique concern in recent times because many countries have mandated the use of face masks as a result of the COVID-19 pandemic. As more people are required to wear face masks, the struggle to communicate intensifies. This struggle is especially severe for those who depend on non-verbal signals to interact with others, such as people who have hearing problems and rely on lip reading to communicate.

Conventional face masks have also failed to meet the needs of wearers with regard to comfort. Many face masks are uncomfortable to wear for long periods of time. This is partially due to the straps of the face mask and partially due to the seal of the face mask. Face mask straps often rub against the ears of the wearer and cause chafing. Additionally, the elastic bands that are sometimes used as face masks straps are often uncomfortable because they pull on the hair of the wearer. The seal between the face mask and the face is also often uncomfortable for the wearer because the mask rubs against the skin, causing irritation. Additionally, for a seal to be formed between the face and the mask that will protect the wearer from harmful particulates, the face mask is pulled tightly against the face by the straps, and the resulting pressure often causes discomfort. Physical harm, including epidermal damage and scarring, may also be caused by prolonged use.

### BRIEF SUMMARY

Embodiments of the disclosure disclosed and taught herein are directed to face masks, including, but not limited to, transparent face masks that protect against harmful particulates and are designed to prevent facial discomfort.

In some embodiments, the disclosure includes a face mask comprising a body forming a central portion that includes a material exhibiting a refractive index between 1.2 and 1.7, at least one strap for securing the face mask to a wearer's head, and an element located and configured to enable adjustment of a pressure between the face mask and a wearer's face.

Another embodiment of the disclosure includes a method for producing a face mask. The method includes forming polymeric fibers into a face mask comprising a body, which forms a central portion of the face mask that includes a transparent material exhibiting a refractive index between 1.2 and 1.7, at least one strap for securing the face mask to a wearer's head, and an element located and configured to enable adjustment of a pressure between the face mask and a wearer's face.

Additional embodiments of the disclosure include a face mask, which includes an inner surface, a sealant that is disposed around a perimeter of the inner surface, an outer surface, and a body forming a central portion that includes a transparent material comprising polymeric nanofibers.

Another embodiment of the disclosure includes a face mask that includes a body, at least one strap for securing the face mask to a wearer's head, and an element that is located and configured to enable adjustment of a pressure between the face mask and a wearer's face. The body forms a central portion and comprises a polymeric material.

### BRIEF DESCRIPTION OF THE DRAWINGS

While the specification concludes with claims particularly pointing out and distinctly claiming what are regarded as embodiments of the disclosure, various features and advantages of this disclosure may be more readily ascertained from the following description of example embodiments provided with reference to the accompanying drawings, in which:

FIG. 1A illustrates a schematic view of an outward-facing side of a face mask in accordance with embodiments of the disclosure;

FIG. 1B illustrates a schematic view of a wearer-facing side of a face mask in accordance with embodiments of the disclosure;

FIG. 2A illustrates a schematic view of an outward-facing side of a face mask in accordance with embodiments of the disclosure;

FIG. 2B illustrates a schematic view of a wearer-facing side of a face mask in accordance with embodiments of the disclosure;

FIG. 3A illustrates a schematic view of a face mask in accordance with embodiments of the disclosure;

FIG. 3B illustrates a schematic view of an element in an open position that is located and configured to enable adjustment of a pressure between a face mask and a wearer's face in accordance with embodiments of the disclosure;

FIG. 3C illustrates a schematic view of an element in a closed position that is located and configured to enable adjustment of a pressure between a face mask and a wearer's face in accordance with embodiments of the disclosure;

FIG. 4 illustrates a cross-sectional view of a face mask in accordance with embodiments of the disclosure; and

FIG. 5 is a flow chart illustrating a method of producing a face mask in accordance with embodiments of the disclosure.

### DETAILED DESCRIPTION

Embodiments of the disclosure disclosed and taught herein are directed to face masks and related methods of manufacturing them, including, but not limited to, transparent face masks that protect against harmful particulates and are designed to prevent facial discomfort.

The following description provides specific details, such as material compositions and processing conditions in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the disclosure are described in detail below. A person of ordinary skill in the art will understand that some process components are inherently disclosed herein and that adding various conventional process components and acts would be in accord with the disclosure.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figure. Unless otherwise specified, the spatially relative terms are intended to encompass different orientations of the materials in addition to the orientation depicted in the figure. For example, if materials in the figure are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “configured” refers to a size, shape, material composition, material distribution, and arrangement of one or more of at least one apparatus facilitating operation of one or more of the structure and the apparatus in a pre-determined way.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used herein, the term “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof.

As used herein, the term “may” with respect to a material, structure, feature or method act indicates that such is contemplated for use in implementation of embodiments of the disclosure and such term is used in preference to the more restrictive term “is” so as to avoid any implication that other, compatible materials, structures, features and methods usable in combination therewith should or must be excluded.

The illustrations presented herein are not actual views of any particular face mask, material, or method, but are merely idealized representations that are employed to describe embodiments of the disclosure. The figures are not necessary drawn to scale. Additionally, elements common between figures may retain the same numerical designation.

Embodiments of the disclosure include face masks that are comprised of a transparent material that allows others to see a wearer's mouth, as well as face masks that are comfortable to wear for long periods of time. The transparent face masks may include polymeric materials (e.g., polymeric nanofibers) that are formed into a variety of shapes (e.g., a cup, a rectangular layer, a cylindrical layer, etc.) that cover a wearer's nose and mouth. The face masks may further include at least one strap (e.g., a headband) that secure the face mask to a wearer's face. The strap may also include an element located and configured to enable adjustment of a pressure between a face mask and a wearer's face (e.g., an adjustable, quick-release clamp), which may also be configured to adjust the fit of the mask to the wearer's face. For example, the element may be configured to tighten or loosen the straps, and as a result, increase or decrease the pressure of the mask against the wearer's face. The face masks may also include a sealant around the perimeter of the inner surface of the mask, which may be formulated to secure (e.g., seal) the face mask to a wearer's face. The sealant may be comprised of a skin-safe adhesive, such as silicone or latex.

The transparent face masks of the disclosure and methods of producing them are advantageous over conventional face masks because they do not conceal the bottom half of the wearer's face from view. Conversely, the transparent material of the face mask allows others to see the wearer's mouth, which may aid in social interaction between the wearer and others, especially others who may have hearing problems and rely on non-verbal signals (e.g., lip reading) to communicate. Additionally, the transparent face masks of the disclosure are designed to mitigate facial discomfort (e.g., chafing) by utilizing straps that may include lotion, by reducing the pressure required to create a seal between the mask and the face, and by utilizing an adjustable, quick-release clamp that allows the wearer to tailor the fit of the mask to his or her face. As a result, the transparent face masks of the disclosure may protect a wearer from harmful particulates while simultaneously improving the wearer's communicative abilities and comfort.

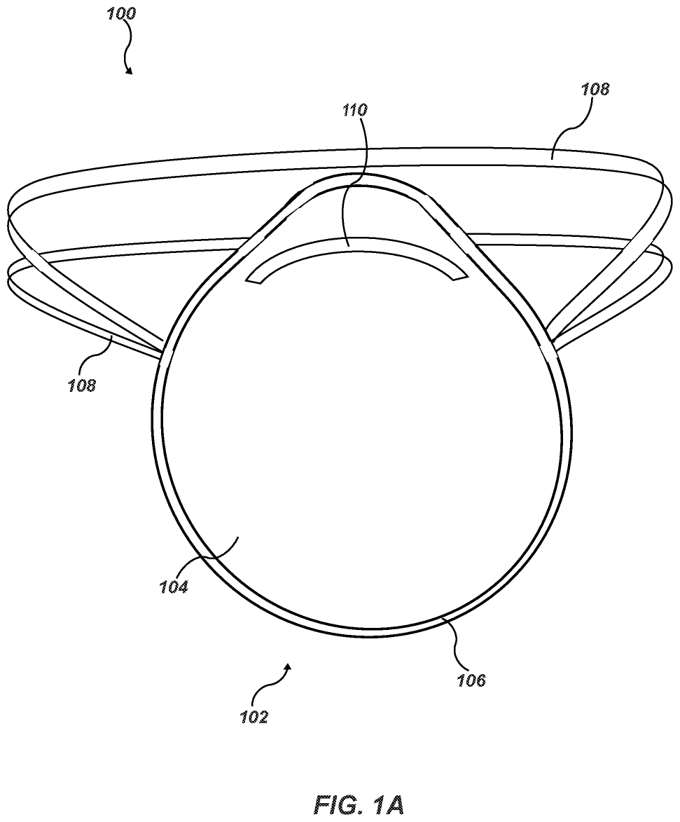

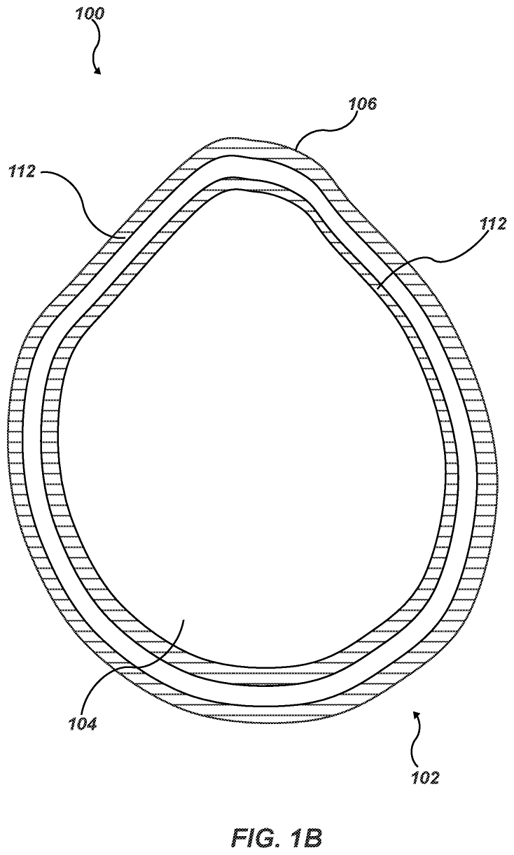

FIG. 1A illustrates a schematic view of an outward-facing side of a face mask 100 in accordance with embodiments of the disclosure. For example, as is described in greater detail below, the face mask 100 may be comprised of a body 102 forming a central portion 104 of the face mask 100 and having a perimeter 106. The body 102 of the face mask 100 may be comprised of at least one layer. The face mask 100 may have at least one strap 108 (e.g., two straps) for securing the face mask to a wearer's head. The at least one strap 108 may be attached to opposite lateral sides of the body 102 of the face mask 100. The face mask 100 may optionally include a nose bridge wire 110 to help tailor the fit of the mask to individual faces.

The face mask 100 may include a body 102 formed to cover (e.g., create a seal around) a wearer's nose and mouth. For example, the body 102 may form a cup shape, similar to the cup shape of N95 and KN95 face masks. The central portion 104 of the body 102 may include a transparent or a translucent material. For example, the central portion 104 may comprise a material exhibiting a refractive index between about 1 and about 2, and more particularly between about 1.2 and about 1.7, when tested in accordance with conventional methods (e.g., measured at the yellow doublet D-line of sodium with a wavelength of 589 nm). Further, the material may exhibit a band gap from about 5 eV to about 10 eV, and more particularly from about 7 eV to about 9 eV at a temperature of about 30° C. As a non-limiting example, the material may include a polymer such as polystyrene, polyester, polyethylene, polyurethane, polypropylene, polycarbonate, polyamides, cyclic polyolefins, polymethylpentene, polytetrafluoroethylene, cellulose-based polymers (e.g., cellulose triacetate, carboxymethylcellulose, etc.), or a combination of two or more of these materials. If a combination of materials is used to form the central portion 104 of the body 102, the materials may exhibit substantially uniform indices of refraction such that the transparency of the central portion 104 is preserved. Further, the central portion 104 may be comprised of polymeric nanofibers formed from the previously mentioned polymers, which may also exhibit a crystalline or a semi-crystalline microstructure. The body 102 as a whole may also include any of the materials described herein with respect to the central portion 104, and different layers of the body 102 may comprise different materials. The body 102 may also be comprised of a material formulated to conform to a wearer's face in order to mitigate facial discomfort. For example, the body 102 may include a shape-memory polymer (e.g., polyurethane, polyethyleneoxide, polyethylene terephthalate, etc.). Other optional components include antimicrobial materials (e.g., silver nanoparticles, copper nanoparticles, etc.), fog-resistant compounds (e.g., a hydrophobic, superhydrophobic, hygroscopic, amphiphilic, hydrophilic, or superhydrophilic coating) embedded, coated, or otherwise incorporated into the body 102 of the face mask 100. Additionally, the face mask 100 may be reusable. For example, if the body 102 of the face mask 100 becomes dirty (e.g., collects unwanted particles such as debris, dust, or lint), it may be cleaned to remove the unwanted particles and may be reused.

The face mask 100 including all of its components (e.g., the face mask as a whole) may be transparent or translucent. For example, the face mask 100 may have a luminous transmittance value of about 50% to about 100%, and more particularly, greater than about 70% (e.g., about 85%) when tested in accordance with the American Society for Testing and Materials Standard Test Method for Haze and Luminous Transmittance of Transparent Plastics, ASTM D1003-13 (2013 revision). In other embodiments, only the body 102 or the central portion 104 of the face mask 100 may be transparent or translucent, and may exhibit substantially the same luminous transmittance values when tested in accordance with ASTM D1003-113 (2013 revision). In yet another embodiment, the face mask 100 may include polymeric materials that are neither transparent nor translucent. For example, the face mask 100 may include polymeric materials that are opaque. As a non-limiting example, these materials may include polyethylene, polypropylene, polyvinylchloride, polytetrafluoroethylene, nylon, and thermoplastic polyurethanes that are manufactured such that they are not transparent. In this embodiment, the face mask 100 may further include materials exhibit a refractive index that is greater than 2 when tested in accordance with conventional methods (e.g., measured at the yellow doublet D-line of sodium with a wavelength of 589 nm).

The face mask 100 may also include at least one strap 108 (e.g., two straps) for securing the face mask to a wearer's head. The at least one strap 108 may be attached to opposite lateral sides of the body 102 of the face mask 100. The at least one strap 108 may be worn around a wearer's head or around a wearer's ears to secure the face mask 100 to a wearer's face. The at least one strap 108 may include at least one polymeric material, such as an elastomer (e.g., polyisoprene, polybutadiene, polychloroprene, other rubbers, latex, etc.), and may be wrapped in a soft material such as a textile fiber (e.g., polyester, cotton, acetate, rayon, silk, etc.). Further, the at least one strap 108 may include a lotion formulated to soothe a wearer's skin. The lotion may transfer from the strap to the wearer's skin upon use of the face mask 100. The lotion may include softening/debonding agents, emollients, immobilizing agents, and mixtures thereof. For example, suitable softening/debonding agents may include quaternary ammonium compounds, polysiloxanes, and mixtures thereof. Suitable emollients may include, for example, propylene glycol, glycerine, triethylene glycol, waxes, petrolatum fatty acids, fatty alcohols and fatty alcohol ethers, mineral oil, such as silicone oil (e.g., dimethicone and isopropyl palmitrat), and mixtures thereof. Suitable immobilizing agents may include, for example, waxes, fatty alcohols, fatty acids (e.g., ceresin wax, microcrystalline wax, petroleum waxes, fisher tropsh waxes, paraffin waxes, stearyl alcohol, and paraffins), polyhydroxy fatty acid esters, polyhydroxy fatty acid amides, and mixtures thereof. The lotion may comprise an emulsion or dispersion. Other optional components may include antimicrobial agents and disinfectants. Particular examples of lotion components may include, for example, vitamin E, camphor, thymol, chamomile extracts, Aloe vera, Calendula officinalis, and combinations of two or more of these components. The lotion may be infused, coated, or otherwise incorporated into the at least one strap 108. The lotion may also be infused, coated, or otherwise incorporated into any component of the face mask 100 (e.g., the body 102), especially into those components that contact a wearer's face. The lotion may prevent chafing and other facial discomfort where components of the face mask 100 contact a wearer's face.

The optional nose bridge wire 110 may be located toward the upper portion of the face mask 100 near a wearer's nose, and may be used to help further conform the face mask 100 to a wearer's face. The nose bridge wire 110 may include materials disclosed herein, as well as aluminum or other materials known in the art.

FIG. 1B illustrates a schematic view of a wearer-facing side of a face mask 100 in accordance with embodiments of the present disclose. For example, as was described previously with respect to FIG. 1A, the face mask 100 may include a body 102 forming a central portion 104 and having a perimeter 106. The body 102 may include a sealant 112 disposed around a perimeter 106 of the body 102 (e.g., on the inner surface) that is formulated to secure the face mask 100 to a wearer's face. The sealant 112 may form at least one ridge (e.g., a plurality of ridges) around the perimeter 106 of the face mask 100. The width of the ridge of sealant 112 may be in a range from about 0.1 microns to about 5 millimeters, and more particularly, from about 100 microns to about 1 millimeter (e.g., about 120 microns). If a plurality of ridges is present, the ridges may be spaced apart by, for example, about 5 mm. The ridge of sealant 112 may comprise, for example, microscopic dots, a continuous line, or another pattern of sealant 112 that is disposed around the perimeter 106 of the body 102 of the face mask 100. The sealant 112 may be disposed around the perimeter 106 by spray coating, dip coating, or otherwise applying the sealant 112 to the perimeter 106 of the face mask 100.

The sealant 112 may be formulated to secure (e.g., seal) the face mask 100 to a wearer's face while simultaneously preventing facial discomfort. For example, the sealant may include a skin-safe adhesive, such as silicone, latex, latex-acrylic, mastic, or combinations thereof Additionally, the sealant 112 may include a pressure-sensitive adhesive (e.g., an elastomer compounded with a suitable tackifier). The sealant 112 may also be reusable. For example, if the at least one ridge of sealant 112 becomes dirty (e.g., collects unwanted particles such as debris, dust, or lint), it may be cleaned to remove the unwanted particles and restore the sealant properties. The face mask 100 may additionally include any of the materials and components described with respect to the face mask 100 of FIG. 1A, and may also exhibit the same properties. For example, the sealant 112 may optionally comprise a lotion, such as the lotion described above with respect to FIG. 1A. In some embodiments, the sealant 112 comprises an adhesive material that secures the face mask to a wearer's face without the use of the at least one strap 108. In such embodiments, the face mask may be strapless. In additional embodiments, the at least one strap 108 for securing the face mask to a wearer's head described with respect to FIG. 1A is optional and may be attached to opposite lateral sides of the body 102 for additional security.

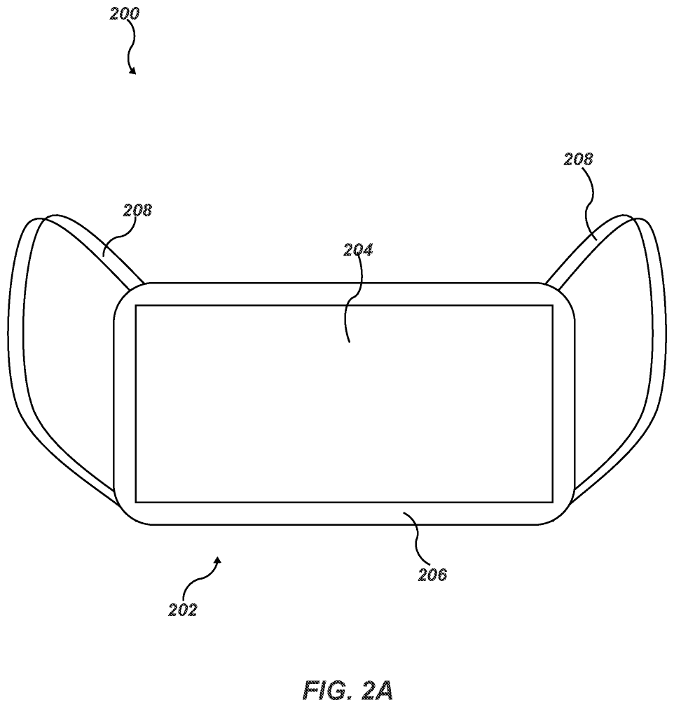

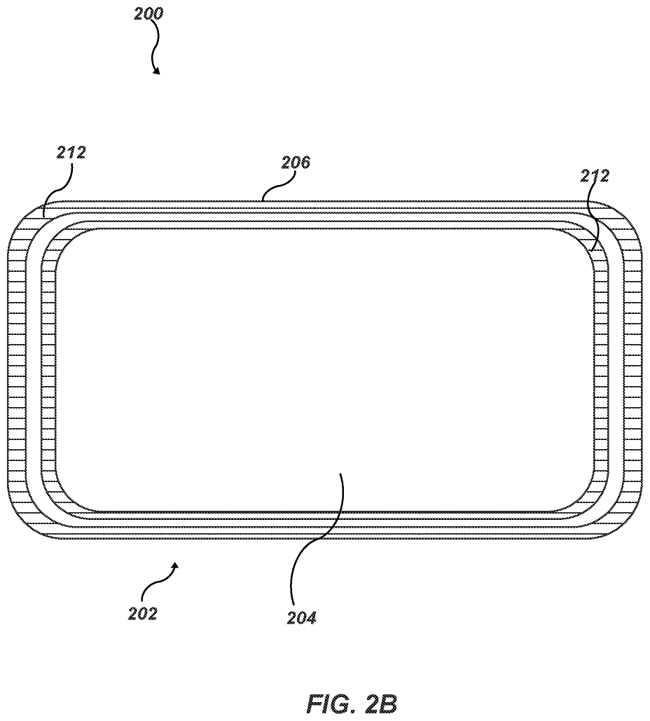

FIG. 2A illustrates a schematic view of an outward-facing side of a face mask 200 in accordance with embodiments of the disclosure. Similar to the face mask 100 described above with respect to FIG. 1A, the face mask 200 may include a body 202 forming a central portion 204 of the face mask 200, as well as a perimeter 206. The body 202 of the face mask 200 may also be comprised of at least one layer. Furthermore, similarly to the face mask 100 described above with respect to FIG. 1A, the face mask 200 may include at least one strap 208 (e.g., two straps) for securing the face mask to a wearer's head. The at least one strap 208 may be attached to opposite lateral sides of the body 202 of the face mask 200.

However, instead of a body 102 forming a cup shape, the body 202 may form a rectangular shape, similar to a surgical mask. The body 202 may also form any other shape that covers a wearer's nose and mouth. For example, the shape may be cylindrical or rectangular and the central portion 204 may be pleated, allowing for vertical expansion (e.g., stretching) to improve the coverage over a wearer's nose and mouth during use. The at least one strap 208 (e.g., two straps) may be worn around a wearer's ears, or may be worn around a wearer's head as a headband, to secure the face mask 200 to a wearer's face. The face mask 200 including the body 202 and at least one strap 208 may include the same materials and components, may exhibit the same properties, and may be produced and used in substantially the same manner as the face mask 100 including the body 102 and at least one strap 108 described above with respect to FIG. 1A.

FIG. 2B illustrates a schematic view of a wearer-facing side of a face mask 200 in accordance with embodiments of the disclosure. For example, as described previously with respect to FIG. 2A, the face mask 200 may include a body 202 forming a central portion 204 and having a perimeter 206. Similar to the face mask 100 described above with respect to FIG. 1B, the body 202 may include a sealant 212 formed into at least one ridge (e.g., a plurality of ridges) disposed around the perimeter 206 of the face mask 200. The face mask 200 including the body 202 and sealant 212 may include the same materials, components, and dimensions (e.g., widths), and may be produced and used in substantially the same manner as the face mask 100 including the body 102 and sealant 112 described above with respect to FIGS. 1A-1B.

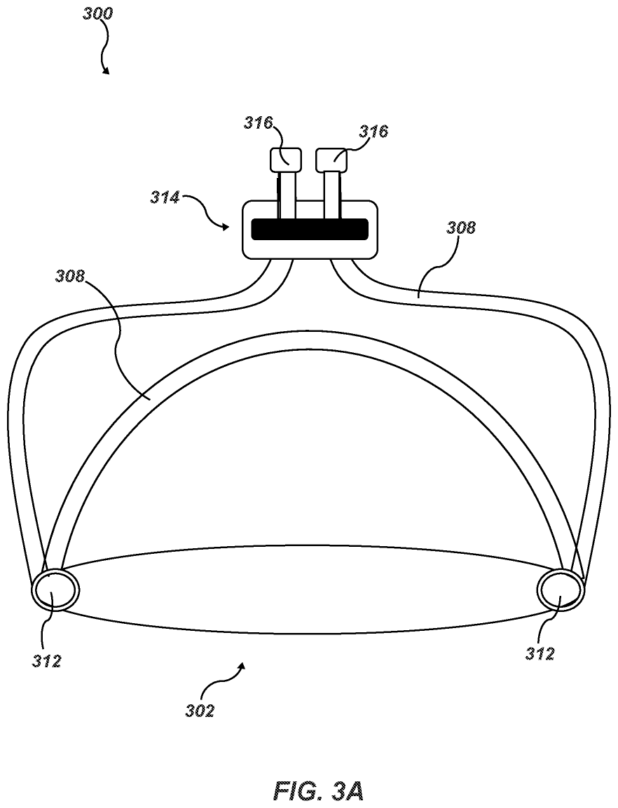

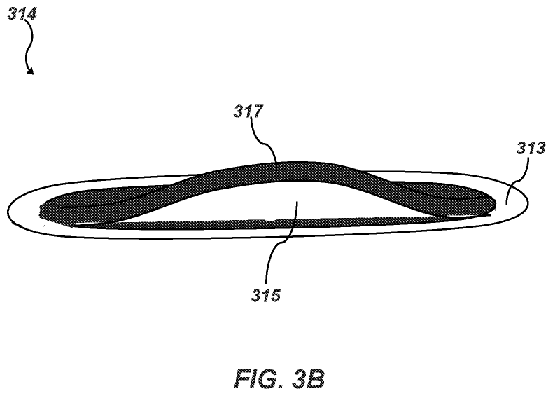

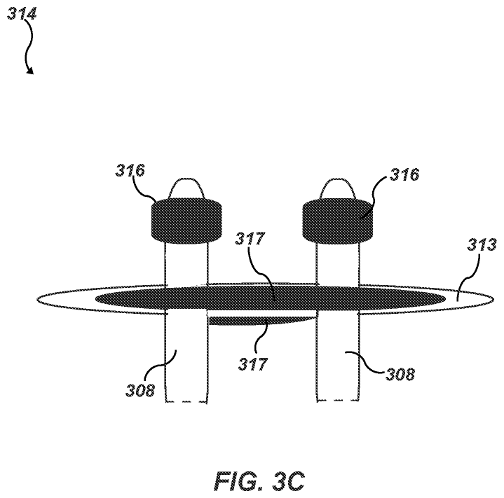

FIG. 3A illustrates a schematic view of a face mask in accordance with embodiments of the disclosure. The face mask 300 may include a body 302, at least one strap 308 for securing the face mask to a wearer's head, at least one optional strap attachment ring 312, an element 314 located and configured to enable adjustment of a pressure between a face mask and a wearer's face, and strap ends 316. The face mask 300 may include any of the embodiments described above in regard to face masks 100 and 200. As such, the body 302 may include the bodies 102, 202, and the at least one strap may include the at least one strap 108, 208 for securing the face mask to a wearer's head. The at least one optional attachment ring 312 may be attached to opposite lateral sides of the body 302 of the face mask 300, and may be configured to attach and/or adjust the at least one strap 308 around a wearer's face. For example, the at least one strap 308 may loop through the at least one optional attachment ring 312, and the strap ends 316 may be fed through the element 314, which may be adjusted to fit the face mask 300 to a wearer's face. Slots in the body 302 of the face mask 300 may also be used to attach the at least one strap 308 to the body 302, or another attachment mechanism may be employed (e.g., the at least one strap 308 may be sewed, adhered, or otherwise attached to the body 302 of the face mask 300). The strap ends 316 may be tied into a knot and may include, for example, beads (e.g., stoppers) that prevent the straps from slipping out of the element 314.

FIG. 3B illustrates a schematic view of an element 314 located and configured to enable adjustment of a pressure between a face mask and a wearer's face (e.g., an adjustable, quick-release clamp) in accordance with embodiments of the disclosure. In an open position shown in FIG. 3B, the element 314 may comprise an outer portion 313, an aperture 315, and a midsection 317. Referring to FIGS. 3A-3B together, the element 314 may be configured to quickly release the midsection 317 holding the at least one strap 308 in place. For example, from the initial open position shown in FIG. 3B, the strap ends 316 may be fed through the aperture 315, and the midsection 317 may be pressed (e.g., clamped) down into pressured contact with the at least one strap 308, resulting in the midsection 317 becoming almost flush with the outer portion 313. This closed position is shown in FIG. 3C. The pressured contact creates a frictional force of sufficient magnitude to hold the at least one strap 308 in place. Thus, a pressure between the face mask 300 and a wearer's face may be adjusted by feeding the at least one strap 308 through the element 314 (e.g., by tightening or loosening the strap) while the element 314 is in the open position, and pressing the clamp down into the closed position when the desired pressure between the face mask 300 and a wearer's face is achieved. In some embodiments, more than one element 314 is present (e.g., at least two elements may be present) that are located and configured to adjust a pressure between the face mask 300 and a wearer's face.

FIG. 3C illustrates a schematic view of an element 314 located and configured to enable adjustment of a pressure between a face mask and a wearer's face 314 (e.g., an adjustable, quick-release clamp) in accordance with embodiments of the disclosure. In a closed position shown in FIG. 3C, the element 314 may comprise an outer portion 313 and a midsection 317. The at least one (e.g., two) face mask straps 308 enter into the element 314 through the aperture 315 shown in FIG. 3B. In the closed position, the midsection 317 may be pressed (e.g., clamped) down into pressured contact with the at least one strap 308, resulting in the midsection 317 becoming almost flush with the outer portion 313. As described above, the pressured contact creates a frictional force of sufficient magnitude to hold the at least one strap 308 in place. Thus, a pressure between the face mask 300 and a wearer's face may be adjusted by feeding the at least one strap 308 through the element 314 (e.g., by tightening or loosening the strap) while the element 314 is in the open position, and pressing the clamp down into the closed position when the desired pressure between the face mask 300 and a wearer's face is achieved. The element 314 may thus mitigate facial discomfort resulting from the pressure between the face mask 300 and the wearer's face. To quickly release the element 314, the opposite lateral sides of the outer portion 313 may be pressed (e.g., flexed) in a direction opposite to that of the midsection 317 to move the midsection 317 into the open position shown in FIG. 3B. The element 314 may thus expedite a removal and/or adjustment of the face mask 300, and may be used as a quick-release clamp. As used herein, the term “quick-release clamp” and its grammatical equivalents means and includes an element located and configured to enable adjustment of a pressure between a face mask and a wearer's face, which is able to adjust and/or release the pressure in three seconds or less. The element 314 may be comprised of a flexible material that is capable of withstanding high cycle fatigue (e.g., a metal, metal alloy, polymer, etc.).

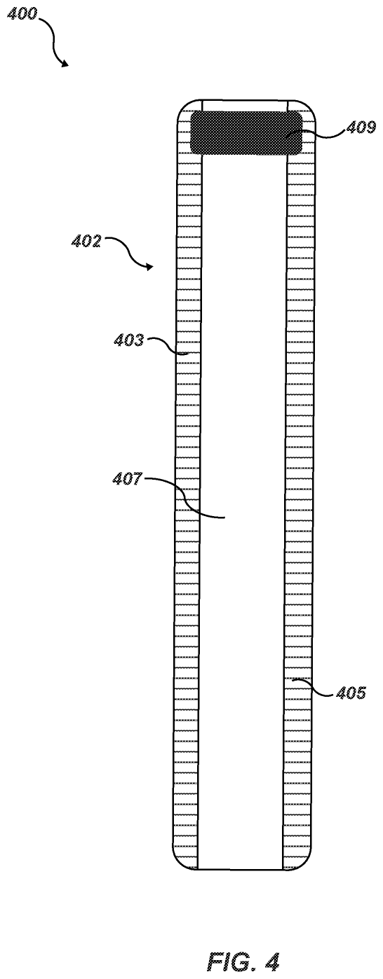

FIG. 4 illustrates a cross-sectional view of a face mask 400 in accordance with embodiments of the disclosure. As is described in greater detail below, a cross-section of a face mask 400 may include a plurality of layers 403, 405, 407 forming a body 402 of the face mask 400 and an optional filtration component 409 disposed within the face mask 400. Layer 403 may form the wearer-facing side of the face mask 400, and layer 405 may form the outward-facing side of the face mask 400. Layer 407 may be disposed in between layer 403 and layer 405. A greater plurality of layers (e.g., more than three) may also be present within the body 402. The face mask 400 may include any of the embodiments described above in regard to face masks 100, 200, 300 and may include any and/or all of their respective components. For example, the body 402 may include the bodies 102, 202, 302 described above. As such, the materials that each layer is comprised of may also include any of the materials and components described above with respect to FIGS. 1A-3B, and may exhibit substantially the same properties.

The optional filtration component 409 be located anywhere within or on the face mask 400. For example, the filtration component 409 may be located within any of the layers 403, 405, 407, or may be disposed on the surface of layer 403 or on the surface of layer 405. The filtration component 409 may be located toward the bottom of the face mask 400 toward a wearer's chin, or may be located on either lateral end of the face mask 400 toward a wearer's ears. Multiple filtration components 409 may also be present within the face mask 400. As a non-limiting example, the optional filtration component 409 may comprise a UV filtration system, which may propagate UV waves in the face mask 400 (e.g., throughout the fibers of the face mask 400), thus destroying pathogenic microorganisms and sterilizing the mask. Further, the materials that the body 402 of the face mask 400 includes may act as a filter. For example, the material of the face mask (e.g., polymeric nanofibers) may be formed into a face mask in such a way that the mask is still breathable (e.g., air may enter and exit the mask), but harmful particulates are prevented from entering the face mask 400. For example, the spacing between the polymeric nanofibers in the face mask 400 may be smaller than about 120 nanometers to prevent pathogenic microorganisms from penetrating through the face mask 400. The face mask 400 may be formed from materials that are transparent, while still being capable of filtration. Further, the face mask 400 does not have to consist solely of the material behaving as a filter (e.g., polymeric nanofibers). As a non-limiting example, the filtration material may be located anywhere around a perimeter of the face mask. In some embodiments, the filtration material may also comprise most of the body 402 of the face mask 400, but may not comprise the central portion (e.g., 104, 204) of the face mask. The filtration material may only be present in one layer of the face mask, or may be present in every layer of the face mask. The filtration material may be located away from a wearer's nose and mouth (e.g., on opposite lateral ends of the face mask 400 toward a wearer's ears or near the bottom of the face mask 400 toward a wearer's chin) to provide greater visibility of the wearer's nose and mouth.

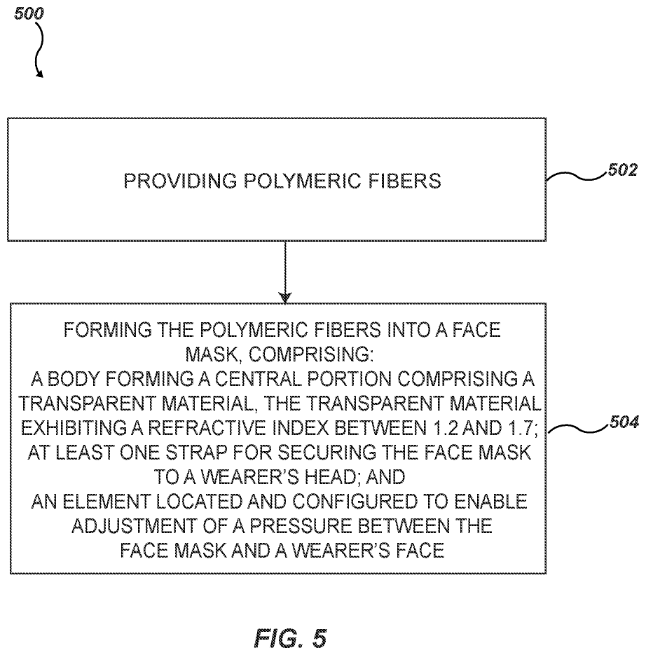

FIG. 5 is a flow chart 500 illustrating a method of producing a face mask in accordance with embodiments of the disclosure. As shown in act 502, polymeric fibers (e.g., polymeric nanofibers) may be provided. The polymeric fibers may be comprised of any of the polymeric materials previously discussed with respect to FIGS. 1A-4. The polymeric fibers may be produced through any suitable process, such as melt blowing, electrospinning, phase separation, self-assembly, and the like.

As shown in act 504, the polymeric fibers (e.g., polymeric nanofibers) may be formed into a face mask. The face mask may include any of the embodiments described above with respect to FIGS. 1A-4. As a non-limiting example, the polymeric fibers may be formed into a non-woven face mask using a melt blowing process. The polymeric fibers of the face mask may be formed into a face mask in such a way that the face mask is still breathable (e.g., air may enter and exit the mask), but harmful particulates are prevented from entering the face mask. For example, the spacing between the polymeric fibers in the face mask may be smaller than about 120 nanometers to prevent pathogenic microorganisms from penetrating through the face mask. Further, the polymeric fibers may oriented relative to each other such that the transparency of the face mask is maintained. For example, the face mask as a whole may be transparent or translucent. For example, the face mask may have a luminous transmittance value of about 50% to about 100%, and more particularly, greater than about 70% (e.g., about 85%) when tested in accordance with the American Society for Testing and Materials Standard Test Method for Haze and Luminous Transmittance of Transparent Plastics, ASTM D1003-13 (2013 revision). In other embodiments, only the body 102 or the central portion 104 of the face mask 100 may be transparent or translucent, and may exhibit substantially the same luminous transmittance values when tested in accordance with ASTM D1003-113 (2013 revision).

The face mask may include a body forming a central portion, which may include a transparent material exhibiting a refractive index between about 1 and about 2, and more particularly, between about 1.2 and about 1.7. The face mask may further include at least one strap for securing the face mask to a wearer's head, and an element located and configured to enable adjustment of a pressure between a face mask and a wearer's face.

The method may optionally include mixing an additive into the polymeric fibers before they are formed into a face mask or during the formation process. The additive may include, for example, materials discussed above with respect to FIGS. 1A-4. For instance, the additive may include antimicrobial materials (e.g., silver nanoparticles, copper nanoparticles, etc.), and/or fog-resistant compounds (e.g., a hydrophobic, superhydrophobic, hygroscopic, amphiphilic, hydrophilic, or superhydrophilic coating) that are embedded, coated, or otherwise incorporated into the polymeric fibers of the face mask.

Although the foregoing descriptions contain many specifics, these are not to be construed as limiting the scope of the disclosure, but merely as providing certain exemplary embodiments. Similarly, other embodiments of the disclosure may be devised that do not depart from the scope of the disclosure. For example, features described herein with reference to one embodiment may also be provided in others of the embodiments described herein. The scope of the embodiments of the invention is, therefore, indicated and limited only by the appended claims and their legal equivalents, rather than by the foregoing description. All additions, deletions, and modifications to the disclosure, as disclosed herein, which fall within the meaning and scope of the claims, are encompassed by the disclosure.

What is claimed is:

1. A face mask, comprising:
a body forming a central portion comprising a transparent material, the transparent material exhibiting a refractive index between 1.2 and 1.7;
at least one strap for securing the face mask to a wearer's head; and
an element located and configured to enable adjustment of a pressure between the face mask and a wearer's face.

2. The face mask of claim 1, wherein the body comprises at least one layer of the face mask.

3. The face mask of claim 1, wherein the transparent material exhibiting a refractive index between 1.2 and 1.7 comprises a polymeric material.

4. The face mask of claim 3, wherein the polymeric material comprises polymeric nanofibers.

5. The face mask of claim 1, further comprising a fog-resistant material coating the body.

6. The face mask of claim 5, wherein the fog-resistant material comprises a hydrophobic material.

7. The face mask of claim 1, further comprising an antimicrobial material embedded in the body.

8. The face mask of claim 1, wherein the transparent material exhibiting a refractive index between 1.2 and 1.7 comprises a shape-memory polymer.

9. The face mask of claim 1, wherein the at least one strap comprises a lotion.

10. The face mask of claim 1, wherein the element located and configured to enable adjustment of a pressure between the face mask and a wearer's face comprises a quick-release clamp.

11. A method for producing a face mask, comprising:
providing polymeric fibers;
forming the polymeric fibers into a face mask comprising:
a body forming a central portion comprising a transparent material, the transparent material exhibiting a refractive index between 1.2 and 1.7;
at least one strap for securing the face mask to a wearer's head; and
an element located and configured to enable adjustment of a pressure between the face mask and a wearer's face.

12. The method of claim 11, wherein providing polymeric fibers comprises producing polymeric nanofibers using a melt blowing process.

13. The method of claim 11, further comprising embedding an antimicrobial material into the face mask.

14. The method of claim 11, further comprising applying a fog-resistant coating to the polymeric fibers.

15. A face mask, comprising:
an inner surface;
a sealant disposed around a perimeter of the inner surface;
an outer surface; and
a body comprising a transparent material, the transparent material comprising polymeric nanofibers.

16. The face mask of claim 15, wherein the sealant forms at least one ridge around the perimeter of the inner surface.

17. The face mask of claim 15, wherein the at least one ridge comprises a width of less than one millimeter.

18. The face mask of claim 15, wherein the sealant comprises silicone.

19. The face mask of claim 15, wherein the sealant comprises latex.

20. The face mask of claim 15, further comprising a filtration component located in the face mask.

21. A face mask, comprising:
a body forming a central portion comprising a polymeric material;
at least one strap for securing the face mask to a wearer's head; and
an element located and configured to enable adjustment of a pressure between the face mask and a wearer's face.
